(19) United States
(12) Patent Application Publication
(10) Pub. No.: US 2014/0135055 A1
(43) Pub. Date: May 15, 2014

(54) APPARATUS AND METHOD FOR CONTROLLING TRANSMITTING POWER CONTROL IN CARRIER AGGREGATION SYSTEM ACROSS THE ENBS AND DEVICE

(71) Applicant: Samsung Electronics Co., Ltd, Gyeonggi-do (KR)

(72) Inventors: Jingxing Fu, Beijing (CN); Yingyang Li, Beijing (CN); Chengjun Sun, Beijing (CN)

(73) Assignee: Samsung Electronics Co., Ltd, Gyeonggi-do (KR)

(21) Appl. No.: 14/077,057

(22) Filed: Nov. 11, 2013

(30) Foreign Application Priority Data
Nov. 9, 2012 (CN) 201210447339.7

(51) Int. Cl. H04W 52/18; H04W 52/46

(52) U.S. Cl. CPC H04W 52/18; H04W 52/46
USPC 455/522

(57) ABSTRACT

A method and terminal device for power control in a carrier aggregation system across the eNBs includes: a UE receiving semi-static power control parameters, as well as transmission power control commands TPC, from PCell eNB and SCell eNB; and, the UE controls a transmitting power for transmitting HARQ feedback information on PUCCH resource, according to the semi-static power control parameters and the TPC. A method includes computing the corresponding, maximum transmitting power available under the current condition and properly configuring the transmitting power at the terminal device by comprehensive analysis of the power control parameters received from a plurality of eNBs so as to optimize the performances of the communication system.

### CROSS-REFERENCE TO RELATED APPLICATION(S) AND CLAIM OF PRIORITY

The present application is related to and claims the benefit under 35 U.S.C. §119(a) of a Chinese Patent Application filed in the Chinese Patent Office on Nov. 9, 2012 and assigned Serial No. 201210447339.7, the entire disclosure of which is incorporated herein by reference.

### TECHNICAL FIELD

The present disclosure refers to an apparatus and method for controlling transmitting power in a carrier aggregation system across the evolved Node B (eNBs).

### BACKGROUND

In the existing Long Term Evolution (LTE) system, the maximum bandwidth supported by a cell is 20 MHz. In order to improve the peak rate for User Equipment (UE), the LTE-Advanced system introduces the technology of carrier aggregation, by which one UE simultaneously communicates with several cells which are working at different carrier frequencies and controlled by the same evolved Node B (eNB). This allows a transmission bandwidth up to 100 MHz and theoretically improves the uplink and downlink peak rate of the UE, by multiples.

For the UEs working under carrier aggregation, the aggregated cells are classified into the Primary Cell (PCell) and the Secondary Cell (SCell).

In the existing LTE/LTE-A system, the transmitting power of an uplink sub-frame is controlled by the eNB which informs the UE of static and semi-static, uplink power control parameters through broadcast message and the message of Radio Resource Control (RRC) layer. For each uplink sub-frame, the UE determines the transmitting power of the Hybrid Automatic Retransmit request (HARQ) feedback information carried on the current sub-frame by means of these uplink power control parameters and the power control commands previously received from the Physical Downlink Control Channel (PDCCH).

During the transmission of the HARQ feedback information, currently, the HARQ feedback information is only transmitted to one eNB, and the power of the Physical Uplink Control Channel (PUCCH) carried on the sub-frame i of a cell c is determined by the formula as follows:

$${P}_{PUCCH} ( i ) = min \{ \begin{matrix}{P}_{CMAX , c} ( i ) , \\ \begin{matrix}{P}_{O\_PUCCH} + {PL}_{c} + h ( {n}_{CQI} , {n}_{HARQ} , {n}_{sr} ) + \\ {Δ}_{F\_PUCCH} ( F ) + {Δ}_{T \times D} ( {F}^{′ } ) + g ( i )\end{matrix}\end{matrix} \} [ dBm$$

wherein, the explanations for respective physical parameters may be found in 36.213 of 3rd Generation Partnership Project (3GPP) protocols by reference.

For an inter-eNB system, the HARQ feedback information is to be transmitted to two or more eNBs. However, the uplink power control parameters, for example, the path loss during the transmission from UE to eNB, the interferences subjected by the eNB, and the covering radius of a cell in the eNB, are all varied with the eNBs. In order to ensure all the receiving Signal to Interference and Noise Ratio (SINR) s of different eNBs upon the arrival of the HARQ feedback information transmitted by the UE can meet the requirements, the power control method of the inter-eNB system needs to be re-determined.

Therefore there is a need to propose an effective technical solution to solve the power controlling problems that exist in the carrier aggregation system across the eNBs.

### SUMMARY

To address the above-discussed deficiencies, embodiments of the present disclosure are provided to optimize the performances of the communication system by comprehensively analyzing the received power control parameters and properly configuring the transmitting power of the terminal devices.

Certain embodiments of the present disclosure include a method for power control in a carrier aggregation system across the eNBs comprising the following steps: UE receives semi-static power control parameters, as well as Transmission Power Control (TPC) commands, from PCell eNB and SCell eNB respectively; and UE controls transmitting power for transmitting HARQ feedback information on PUCCH resource, according to the semi-static power control parameters and the TPC.

Certain embodiments of the present disclosure include a terminal device comprising a receiving module, a power controlling module, and a transmitting module. The receiving module is used for receiving semi-static power control parameters, as well as transmission power control commands TPC, from PCell eNB and SCell eNB respectively. The power controlling module is used for controlling a transmitting power for transmitting HARQ feedback information on PUCCH resource, according to the semi-static power control parameters and the TPC. The transmitting module is used for transmitting the HARQ feedback information through the PUCCH resource according to the transmitting power being controlled.

The technical solutions of the present disclosure include computing the corresponding maximum transmitting power available under the current condition and properly configuring the transmitting power at the terminal device by comprehensive analysis of the power control parameters received from a plurality of eNBs so as to optimize the performances of the communication system. Additionally, the technical solutions of the present disclosure only modify the existing system to a minimized degree, which will not influence the compatibility thereof, and is easily and effectively implemented.

Further aspects and advantages of the invention will be described in details as below, and will become apparent from the following descriptions or will be understood by practice.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the teen “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a schematic view of the Inter-eNB carrier aggregation according to the present disclosure;

FIG. 2 illustrates a flow chart of a process for power control in a carrier aggregation system across the eNBs according to the embodiments of the present disclosure;

FIG. 3 illustrates a schematic view of the information exchange between eNBs according to the embodiments of the present disclosure;

FIG. 4 illustrates a flow chart No. 1 of the reconfiguration of the resource of the feedback information according to the embodiments of the present disclosure;

FIG. 5 illustrates flow chart No. 2 of the reconfiguration of the resource of the feedback information according to the embodiments of the present disclosure;

FIG. 6 illustrates a structural schematic view showing a terminal device according to the embodiments of the present disclosure.

### DETAILED DESCRIPTION

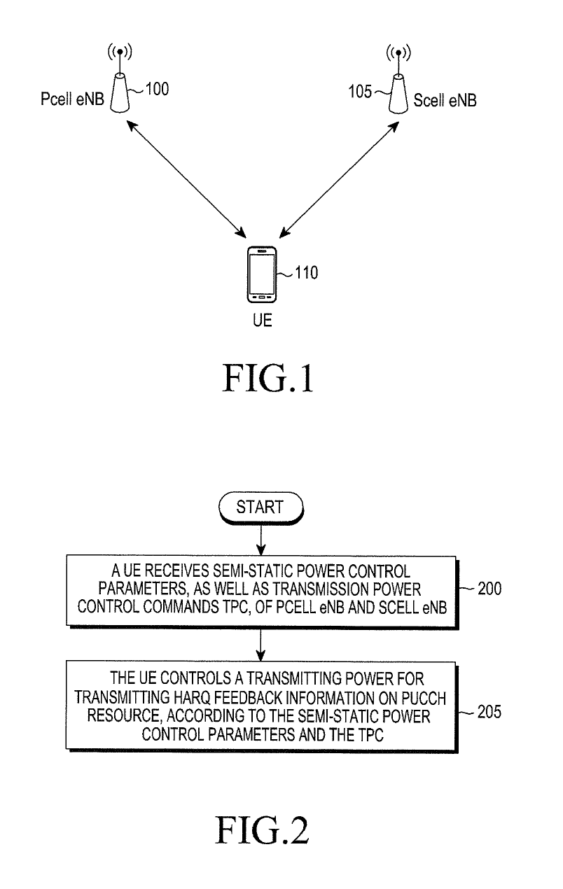

FIGS. 1 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system. The embodiments of the disclosure will be further described in details as below. The embodiments are as shown in drawings, in which same or similar reference numbers represent same or similar elements or elements with same or similar functions. The embodiments described with reference to the drawings are examples, used for explaining the invention, not for limiting the invention.

A person having ordinary skill in the art may understand that “a”, “an”, “said” and “this” may also refer to plural nouns, unless otherwise specifically stated. It should be further understood that, phraseology “include” used in the present disclosure refers to the presence of the characteristics, integers, steps, operations, elements and/or components, but not exclusive of the presence or addition of one or more other characters, integers, steps, operations, elements, components and/or groups thereof. It should be understood that when an element is “connected” or “coupled” to another element, the element can be directly connected or coupled to the other elements, or intermediate elements can be available. In addition, “connection” or “coupling” used herein can include wireless connection or coupling. The phraseology “and/or” includes any one unit and all combinations of one or more associated listed items.

A person having ordinary skill in the art may understand that, unless otherwise defined, terms (including technical terms and scientific teens) used herein have the same meaning as commonly understood by a person having ordinary skill in the art to which this disclosure belongs. It should also be understood that terms such as those defined in commonly used dictionaries should be interpreted as having a meaning that is consistent with their meaning in the context, and will not be interpreted in an idealized or overly formal sense unless expressly so defined herein.

An ordinary person skilled in the art may understand that “terminal” and “terminal equipment” used herein include not only equipment having a radio signal receiver without transmitting function, but also equipment having receiving and transmitting hardware capable of realizing bidirectional communication on bidirectional communication links. Such equipment can include: cellular or other communication equipment with or without a multi-line display; Personal Communication Systems (PCS) that combine voice and data processing, faxing and/or data communication together; Personal Digital Assistants (PDA) that include a radio frequency receiver and a pager, internet/intranet access, a web browser, a notepad, calendar and/or a Global Positioning System (GPS) receiver; and/or a laptop computer and/or palmtop computer including a radio frequency receiver or other equipment. Terms “terminal” and “terminal equipment” used herein can be portable, transportable and installed in vehicles (for aviation, sea transportation and/or land use), or can be suitable for and/or configured to operate locally and/or to operate in any other locations by distributing in the earth and/or space. Terms “terminal” and “terminal equipment” used herein can also be a communication terminal, an internet terminal and an audio/video player terminal, for example, a PDA, a Mobile Information Device (MID) and/or a mobile phone with a music/video playback function. It can be equipment such as a smart TV and a set-top box. Terms “base station” and “base station equipment” are network-side equipment corresponding to “terminal” and “terminal equipment”.

With needs of expanding the application range of the carrier aggregation technology and further increasing the peak rate of UE, the technology of carrier aggregation across the eNBs may become the trend for future development of LTE-Advanced system. In the carrier aggregation across the eNBs, the cells transmitting data with a same UE will no longer necessarily be restricted in the same eNB. These cells can belong to different eNBs, as shown in FIG. 1, among which the eNB including the PCell is referred to as PCell eNB 100, while the eNB exclusively including the SCell is referred to as SCell eNB 105. In this way, the working bandwidth can be increased through carrier aggregation technology even under a network covered by different eNBs.

The embodiments of present disclosure are mainly specific to the systems utilizing carrier aggregation across the eNBs. For PCell eNB and SCell eNB under carrier aggregation, if an X2 interface connection exists there between, a logical connection based on the X2 interface connection is established between PCell eNB and SCell eNB to conduct the signaling exchange. If there is no X2 interface connection, logic connections based on S1 interface connection are established between PCell eNB and MME, and between SCell eNB and MME, respectively, then the signaling exchange between PCell eNB and SCell eNB is conducted through the two established logic connections based on S1, and is forwarded through MME.

In order to achieve the objectives of the present disclosure, a method for power control of HARQ feedback information in a carrier aggregation system across the eNBs is provided herein.

FIG. 1 illustrates a schematic view of the Inter-eNB carrier aggregation according to the present disclosure.

Referring to the FIG. 1, after the PUCCH resource for PCell eNB 100 or other central control nodes to transmit HARQ feedback information is obtained by a UE 110, the UE adjusts the power according to the schemes for power control provided in the present disclosure as shown in FIG. 2,

FIG. 2 is a flow chart of a process for power control in a carrier aggregation system across the eNBs according to the embodiments of the present disclosure;

Referring to the FIG. 2, the schemes comprise step 200 to step 205 as follows.

In step 200, UE (110) receives semi-static power control parameters, as well as transmission power control commands TPC, from the PCell eNB (100) and a SCell eNB (105) respectively.

In step 205, the UE (110) controls a transmitting power for transmitting HARQ feedback information on PUCCH resource, according to the semi-static power control parameters and the TPC.

The UE (110) controls a transmitting power for transmitting HARQ feedback information on PUCCH resource, according to the semi-static power control parameter and the TPC. That is, the UE (110) adjusts the power for transmitting HARQ feedback information by using the maximum determined transmitting power according to the semi-static power control parameters and the TPC. The HARQ feedback information herein corresponds to the HARQ-ACK feedback information in R11 version.

In addition, the UE (110) obtains PUCCH resource for adjusting the transmission of HARQ feedback information from the PCell eNB (100) or other central control nodes. For example, when receiving PUCCH resource information sent from the PCell eNB (100) or SCell eNB (105), the UE sends HARQ feedback information according to the PUCCH resource.

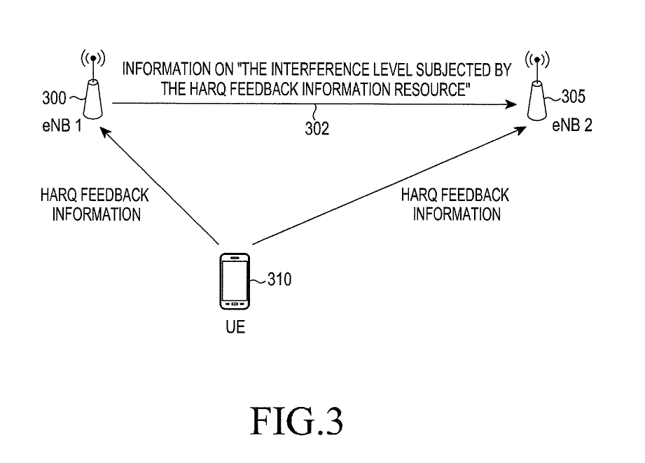

In particular, if the TPC in the PDCCH for an eNB to schedule PDSCH and the TPC in a form corresponding to format 3/3A of various eNBs (if existing) are commands for reducing the power, it indicates the redundancy in the power for transmitting the HARQ feedback information to this eNB. FIG. 3 illustrates a schematic view of the information exchange between eNBs according to the embodiments of the present disclosure. An eNB1 (300) can send information 302 of “the interference level subjected by the HARQ feedback information resource” to other eNBs, e.g. a eNB2 (305) which are serving together for the same UE (310), as shown in FIG. 3

Such information can be values representative the interference levels to be supplied for each group of PRB pairs as feedback, respectively, within the entire system bandwidth or part of the system bandwidth, by taking a group of neighboring PRB pairs as a unit. For example, these values can be the ones for supplying interference levels for each group of PRB pairs as feedback, respectively, by taking the PRB Group prescribed under LTE as a unit, or can be the ones for supplying interference levels for each PRB pair as feedback, respectively, within the entire system bandwidth or part of the system bandwidth, by taking one PRB pair as a unit. Additionally, the information indicating the interference level subjected by the HARQ feedback information resource according to the present disclosure may make a reference to the overload indicating (OI) and high interference information (HII) prescribed under the current LTE provisions. That is, the eNB can utilize the information similar with the overload indicating (OI) and high interference information (HII), but is no longer limited to indicate the interference level of the entire system bandwidth by taking one PRB pair as a unit. In addition, according to the present disclosure, the information indicating the interference level of the conflicted sub-frames is not limited to the overload indicating (OI) or the high interference information (HII), but also can be information indicating the interference level obtained by other methods.

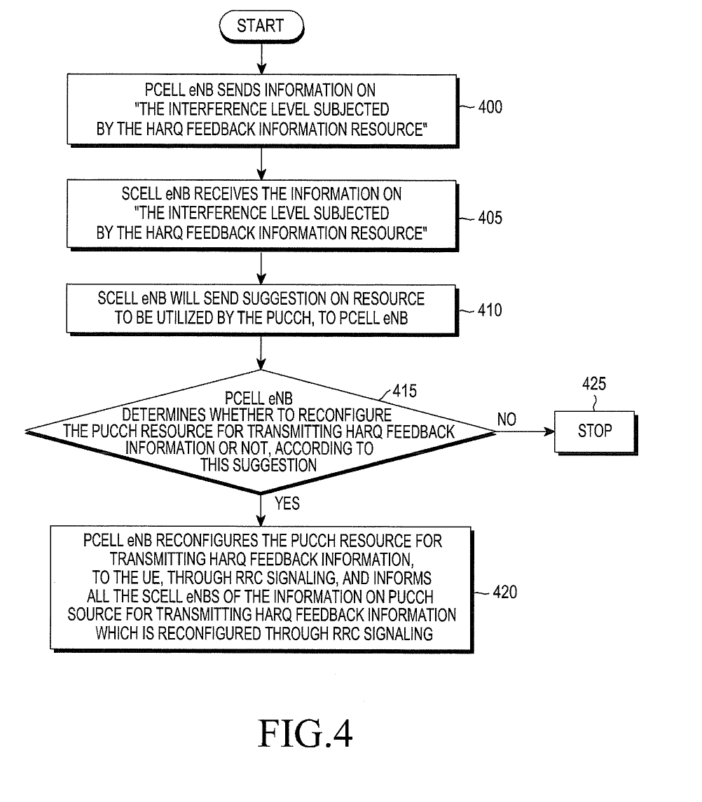

FIG. 4 illustrates flow chart No. 1 of the reconfiguration of the resource of the feedback information according to the embodiments of the present disclosure.

Referring to the FIG. 4, in block 400, if the eNB that sends the information 302 on “the interference level subjected by the HARQ feedback information resource” is a PCell eNB and in block 405, and if the eNB that receives the information 305 on “the interference level subjected by the HARQ feedback information resource” is a SCell eNB, in block 410, the SCell eNB that receives the information 302 on “the interference level subjected by the HARQ feedback information resource” will send a suggestion on resource to be utilized by the PUCCH, to the PCell eNB. The suggestion can be several recommended PRB groups or several recommended PRB pairs. In block 415, the PCell eNB determines whether to reconfigure the PUCCH resource for transmitting HARQ feedback information or not, according to this suggestion; if so, in block 425, the PCell eNB reconfigures the PUCCH resource for transmitting HARQ feedback information, to the UE, through RRC signaling, and informs all the SCell eNBs of the information on PUCCH source for transmitting HARQ feedback information which is reconfigured through RRC signaling, as shown in the flow chart of FIG. 4. If not, in block 425, the PCell eNB stops procedures.

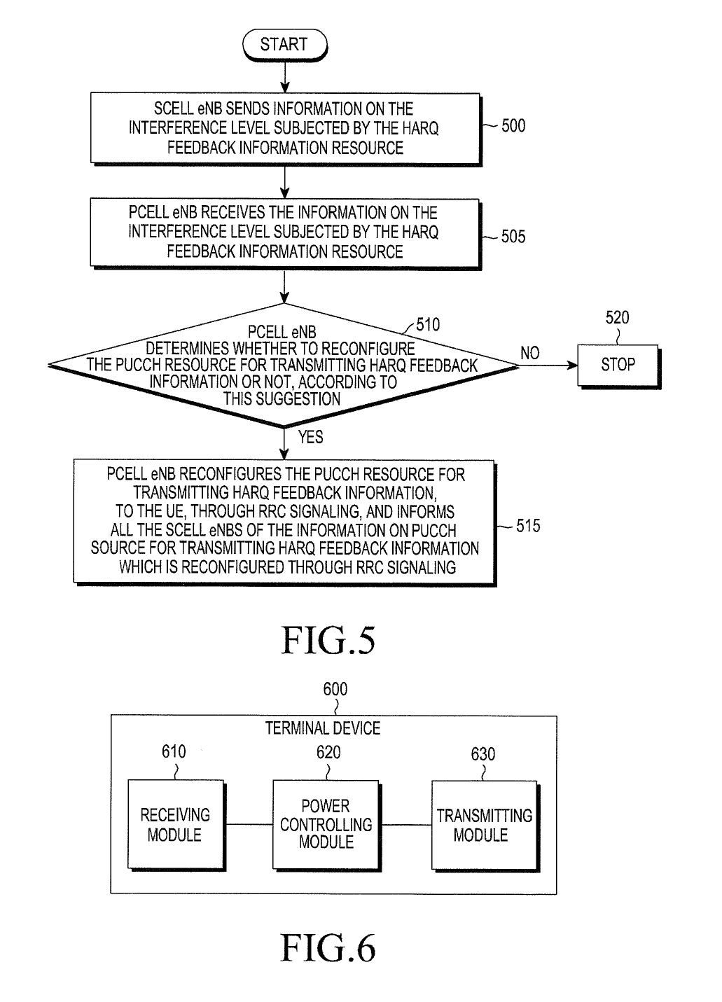

FIG. 5 illustrates a flow chart No. 2 of the reconfiguration of the resource of the feedback information according to the embodiments of the present disclosure. Referring to FIG. 5, in block 500, if the eNB that sends the information 302 on “the interference level subjected by the HARQ feedback information resource” is a SCell eNB and, in block 505, and if the eNB that receives the information on “the interference level subjected by the HARQ feedback information resource” is a PCell eNB, in block 510, the PCell eNB that receives the information 302 on “the interference level subjected by the HARQ feedback information resource” will determine whether to reconfigure the PUCCH resource for transmitting HARQ feedback information or not, according to the information 302 on “the interference level subjected by the HARQ feedback information resource.” If so, in block 515, the PCell eNB reconfigures the PUCCH resource for transmitting HARQ feedback information to the UE, through RRC signaling, and informs all the SCell eNBs of the information on PUCCH source for transmitting HARQ feedback information which is reconfigured through RRC signaling, as shown in the flow chart of FIG. 5. If not, in block 520, the PCell eNB stops procedures.

In the block 200, the UE receives semi-static power control parameters, as well as transmission power control commands TPC, from PCell eNB and SCell eNB respectively;

The semi-static power control parameter includes: P_{O}_{_{—}}_{PUCCH}, Δ_{F}_{_{—}}_{PUCCH} (F), Δ_{TxD} (F′), P_{CMAX,c} (i) and PL_{c}. The semi-static power control parameter is obtained through RRC signaling received by the UE from the PCell; wherein, P_{O}_{_{—}}_{PUCCH}=P_{O}_{_{—}}_{NOMINAL}_{_{—}}_{PUCCH}+P_{O}_{_{—}}_{UE}_{_{—}}_{PUCCH} is a high-level configuration parameter.

In particular, the semi-static power control parameter obtained through RRC signaling includes P_{O}_{_{—}}_{PUCCH}, Δ_{F}_{_{—}}_{PUCCH} (F), Δ_{TxD} (F′), P_{CMAX,c} (i) and PL_{c}. P_{O}_{_{—}}_{PUCCH}=P_{O}_{_{—}}_{NOMINAL}_{_{—}}_{PUCCH}+P_{O}_{_{—}}_{UE}_{_{—}}_{PUCCH} is referred to as a basic, open-loop, working point for PUCCH power control. The parameter P_{O}_{_{—}}_{PUCCH} of power control for transmitting HARQ feedback information to PCell eNB is set as P_{O}_{_{—}}_{PUCCH}^{PeNB}, and the P_{O}_{_{—}}_{PUCCH} parameter of power control for transmitting HARQ feedback information to SCell eNB is set as P_{O}_{_{—}}_{PUCCH}^{SeNB}, both of which are configured for the UE through RRC signaling of PCell.

Δ_{F}_{_{—}}_{PUCCH} (F) is a deviation value of the PUCCH with certain format by comparing to the PUCCH with a format of 1a. The parameter Δ_{F}_{_{—}}_{PUCCH} (F) of power control for transmitting HARQ feedback information to PCell eNB is set as Δ_{F}_{_{—}}_{PUCCH}^{PeNB} (F), and the parameter Δ_{F}_{_{—}}_{PUCCH} (F) of power control for transmitting HARQ feedback information to SCell eNB is set as Δ_{F}_{_{—}}_{PUCCH}^{SeNB} (F), both of which are configured for the UE through RRC signaling of PCell. The certain format of the PUCCH herein refers to the format of PUCCH utilized for the current transmission of HARQ.

Δ_{TxD} (F′) is a deviation value for transmitting PUCCH by using two antenna ports. The parameter Δ_{TxD} (F′) of power control for transmitting HARQ feedback information to PCell eNB is set as Δ_{TxD}^{PeNB} (F′), and the parameter Δ_{TxD} (F′) of power control for transmitting HARQ feedback information to SCell eNB is set as Δ_{TxD}^{SeNB} (F′), both of which are configured for the UE through RRC signaling of PCell.

P_{CMAX,c} (i) the maximum transmitting power on Cell c of a UE, which is configured for the UE through RRC signaling of PCell.

PL_{c} is a path loss computed by UE through a formula which subtracts the RSRP (reference signal received power) measured by the UE from the transmitting power of CRS (cell reference symbol), wherein the transmitting power of the cell reference symbol is read from the system information by the UE. The UE reads the system information of the PCell to obtain the transmitting power of the cell reference symbol, and measures the cell reference symbol of the PCell to obtain the RSRP, then computes the path loss from the PCell eNB to the UE, by subtracting the RSRP of the PCell from the transmitting power of the cell reference symbol of the PCell. The UE reads the signaling for configuring the secondarily primary cell of the Scell eNB or reads the system information of the SCell in the SCell eNB which transmits the HARQ feedback information (such SCell is called as the secondarily primary cell), to obtain the transmitting power of the cell reference symbol of the secondarily primary cell; and measures the cell reference symbol of the secondarily primary cell to obtain the RSRP; then computes the path loss from the SCell eNB to the UE, by subtracting the RSRP of the secondarily primary cell from the transmitting power of the cell reference symbol of the secondarily primary cell.

The parameter δ_{PUCCH} of power control for transmitting HARQ feedback information to PCell eNB is set as δ_{PUCCH}^{PeNB}, which is obtained from the power control command (TPC) in the PDCCH for Cell in PCell eNB to schedule the PDSCH; if a format 3/3A can be used for power control of SCell eNB, the δ_{PUCCH}^{PeNB} can also be obtained from the TPC in a form specific to the format 3/3A of this eNB. The parameter δ_{PUCCH} of power control for transmitting HARQ feedback information to SCell eNB is set as δ_{PUCCH}^{SeNB}, which is obtained from the power control command (TPC) in the PDCCH for Cell in SCell eNB to schedule the PDSCH; if a format 3/3A can be used for power control of SCell eNB, the δ_{PUCCH}^{SeNB} can also be obtained from the TPC in a form specific to the format 3/3A of this eNB.

In the block 205, the UE controls a transmitting power for transmitting HARQ feedback information on PUCCH resource, according to the semi-static power control parameter and the TPC.

In particular, the UE controls the PUCCH resource on sub-frame i to transmit HARQ feedback information at a transmitting power of P_{PUCCH} (i), according to the semi-static power control parameters and the TPC. Wherein the P_{PUCCH} (i) can be computed in various ways including but not limiting to, for example,

$${P}_{PUCCH} ( i ) = {max}_{n = 0}^{N} {P}_{PUCCH}^{( n )} ( i ) ,$$

wherein N is the number of the eNBs configured for the UE, P_{PUCCH}⁽ⁿ⁾ (i) is the transmitting power required by the n^{th} eNB to correctly receive the HARQ feedback information.

$${P}_{PUCCH}^{( n )} ( i ) = min \{ \begin{matrix}{P}_{CMAX , c} ( i ) , \\ \begin{matrix}{P}_{O\_PUCCH}^{( n )} + {PL}_{c}^{( n )} + h ( {n}_{CQI} , {n}_{HARQ} , {n}_{sr} ) + \\ {Δ}_{F\_PUCCH}^{( n )} ( F ) + {Δ}_{T \times D}^{( n )} ( {F}^{′ } ) + {g}^{( n )} ( i )\end{matrix}\end{matrix} \} ,$$

$$g ( i ) = g ( i - 1 ) + {\sum }_{m = 0}^{M - 1} {δ}_{PUCCH} ( i - {k}_{m} ) ,$$

wherein δ_{PUCCH} (i−kₘ) is the value indicated by the TPC in the PDCCH for scheduling PDSCH on downlink sub-frame i−kₘ or the value indicated by the TPC in the form corresponding to the format 3/3A.

Parameters P_{O}_{_{—}}_{PUCCH}⁽ⁿ⁾, PL_{c}⁽ⁿ⁾, Δ_{F}_{_{—}}_{PUCCH}⁽ⁿ⁾ (F), Δ_{TxD}⁽ⁿ⁾ (F′) and g⁽ⁿ⁾ (i) are P_{O}_{_{—}}_{PUCCH}, Δ_{F}_{_{—}}_{PUCCH} (F), Δ_{TxD} (F′), PL_{c}, and g (i) for the n^{th} eNB, respectively, and h (n_{CQI}, n_{HARQ}, n_{SR}) is the 36.213 parameter prescribed under Release 10 of 3GPP protocol.

For example,

$${P}_{PUCCH} ( i ) = min \{ \begin{matrix}{P}_{CMAX , c} ( i ) , \\ {P}_{PUCCH\_O}^{max} + g ( i )\end{matrix} \} ,$$

wherein

$${P}_{PUCCH\_O}^{max} = {max}_{n = 0}^{N} {P}_{PUCCH\_O}^{( n )} ;$$

P_{PUCCH}_{_{—}}_{O} of the n^{th} eNB is set as P_{PUCCH}_{_{—}}_{O}⁽ⁿ⁾, wherein P_{PUCCH}_{_{—}}_{O}=P_{O}_{_{—}}_{PUCCH}+PL_{c}+h (n_{CQI}, n_{HARQ}, n_{SR})+Δ_{F}_{_{—}}_{PUCCH} (F)+Δ_{TxD} (F′),

$$g ( i ) = g ( i - 1 ) + {max}_{n = 0}^{N} ( {{\sum }_{m = 0}}^{M - 1} {δ}_{PUCCH}^{( n )} ( i - {k}_{m} ) ) ,$$

δ_{PUCCH} (i−kₘ) is the value indicated by the TPC in the PDCCH for scheduling PDSCH on downlink sub-frame i−kₘ or the value indicated by the TPC in the form corresponding to the format 3/3A, and N is the number of the eNB configured for the UE.

For example, P_{PUCCH} (i)=P_{PUCCH}_{_{—}}_{O}⁽ⁿ⁾+g⁽ⁿ⁾ (i)

wherein, P_{PUCCH}_{_{—}}_{O}⁽ⁿ⁾=P_{O}_{_{—}}_{PUCCH}⁽ⁿ⁾+PL_{c}⁽ⁿ⁾+h (n_{CQI}, n_{HARQ}, n_{SR})+Δ_{F}_{_{—}}_{PUCCH}⁽ⁿ⁾ (F)+Δ_{TxD}⁽ⁿ⁾ (F′),

$${g}^{( n )} ( i ) = {g}^{( n )} ( i - 1 ) + {max}_{n = 0}^{N} ( {{\sum }_{m = 0}}^{M - 1} {δ}_{PUCCH}^{( n )} ( i - {k}_{m} ) ) ;$$

the initial power adjustment value is set as g⁽ⁿ⁾ (0), and the actual initial transmitting power is adjusted according to the eNB having the maximum P_{PUCCH}⁽ⁿ⁾ (0),

$${P}_{PUCCH} ( 0 ) = {max}_{n = 0}^{N - 1} {P}_{PUCCH}^{( n )} ( 0 ) ,$$

wherein N is the number of the eNB configured for the UE; g⁽ⁿ⁾ (0)=P_{PUCCH} (0)−P_{PUCCHO}_{_{—}}_{O}⁽ⁿ⁾; computing g⁽ⁿ⁾ (i) of the n^{th} eNB for the uplink sub-frame i;

$${\sum }_{m = 0}^{M - 1} {δ}_{PUCCH}^{( n )} ( i - {k}_{m} )$$

is the PUCCH dynamic power adjustment value of each configured eNB, obtained in terms of the TPC for transmitting HARQ feedback information which is currently sent by the n^{th} eNB; M is the number of the downlink sub-frames corresponding to the HARQ feedback information transmitted on the sub-frame i, that is, the HARQ feedback information transmitted on the sub-frame i is the feedback information specific to the M downlink sub-frames.
Parameters P_{O}_{_{—}}_{PUCCH}⁽ⁿ⁾, PL_{c}⁽ⁿ⁾, Δ_{F}_{_{—}}_{PUCCH}⁽ⁿ⁾ (F), Δ_{TxD}⁽ⁿ⁾ (F′) and g⁽ⁿ⁾ (i) are P_{O}_{_{—}}_{PUCCH}, Δ_{F}_{_{—}}_{PUCCH} (F), Δ_{TxD} (F′), PL_{c} and g (i) for the n^{th} eNB, respectively.

Hereafter the technical solutions proposed by the present disclosure will be further illustrated in conjunction with more particular protocol parameters.

The First Application Case

In a method for computing g (i), the computation of g (i) for each eNB of a configured UE is performed independently. That is, g (i) for each eNB is obtained according to g (i−1) value of the same eNB, and is specific to the dynamic power adjustment command of the same eNB, regardless of the g (i−1) value of other eNBs or dynamic power adjustment commands of other eNBs.

For an eNB, generally speaking, the power adjustment value g (i) of uplink sub-frame i is obtained by adding the power adjustment value g (i−1) of uplink sub-frame i−1 to a dynamic power adjustment value indicated by the dynamic power adjustment command in the downlink associative sets, that is,

$$g ( i ) = g ( i - 1 ) + {\sum }_{m = 0}^{M - 1} {δ}_{PUCCH}^{( n )} ( i - {k}_{m} ) ,$$

wherein δ_{PUCCH} (i−kₘ) is the value indicated by the TPC in the PDCCH for scheduling PDSCH on downlink sub-frame i−kₘ or the value indicated by the TPC in a form corresponding to the format 3/3A. For FDD configuration, M=1, k₀=4. For TDD, the values of M and kₘ are varied with different uplink and downlink configurations thereof, and Table 1 shows several particular values for M and kₘ. In Table 1, value M is the number of elements in the downlink associative set, for example, when the uplink and downlink configuration is 1, the downlink associative set is {7,6}, the number of elements in the set is 2, and M=2.

TABLE 1
downlink associative set index K {k₀, k₁, . . . k_{M-1}} for TDD

| uplink and | | | | | | | | | | |
|---|---|---|---|---|---|---|---|---|---|---|
| downlink | sub-frame n | | | | | | | | | |
| configuration | 0 | 1 | 2 | 3 | 4 | 5 | 6 | 7 | 8 | 9 |
| 0 | — | — | 6 | — | 4 | — | — | 6 | — | 4 |
| 1 | — | — | 7, 6 | 4 | — | — | — | 7, 6 | 4 | — |
| 2 | — | — | 8, 7, 4, 6 | — | — | — | — | 8, 7, 4, 6 | — | — |
| 3 | — | — | 7, 6, 11 | 6, 5 | 5, 4 | — | — | — | — | — |
| 4 | — | — | 12, 8, 7, 11 | 6, 5, 4, 7 | — | — | — | — | — | — |
| 5 | — | — | 13, 12, 9, 8, 7, | — | — | — | — | — | — | — |
| | | | 5, 4, 11, 6 | | | | | | | |
| 6 | — | — | 7 | 7 | 5 | — | — | 7 | 7 | — |

In particular, g (i) of power control for transmitting HARQ feedback information to PCell eNB is set as g^{PeNB} (i), then

$${g}^{PeNB} ( i ) = {g}^{PeNB} ( i - 1 ) + {\sum }_{m = 0}^{M - 1} {δ}_{PUCCH}^{PeNB} ( i - {k}_{m} ) ,$$

wherein δ_{PUCCH}^{PeNB} (i−kₘ) is the power control command on downlink sub-frame i−kₘ; g (i) of power control for transmitting HARQ feedback information to SCell eNB is set as g^{SeNB} (i), then

$${g}^{SeNB} ( i ) = {g}^{SeNB} ( i - 1 ) + {\sum }_{m = 0}^{M - 1} {δ}_{PUCCH}^{SeNB} ( i - {k}_{m} ) ,$$

wherein δ_{PUCCH}^{SeNB} (i−kₘ) is the power control command on downlink sub-frame i−kₘ;

It's required that a plurality of eNBs have to correctly receive the HARQ feedback information sent by the UE, with which the transmitting power for UE to send the HARQ feedback information meet. The transmitting power for UE to transmit the HARQ feedback information can be determined by: computing the P_{PUCCH}⁽ⁿ⁾ (i) required for sending the HARQ information of a configured eNB to a different eNB, by a UE, wherein n is the index of eNB; then taking the maximum of the P_{PUCCH}⁽ⁿ⁾ (i) required for sending the HARQ information of a configured eNB to a different eNB as the transmitting power of the UE, that is,

$${P}_{PUCCH} ( i ) = {{max}_{n = 0}}^{N} {P}_{PUCCH}^{( n )} ( i ) ,$$

wherein N is the number of eNBs configured by the UE, P_{PUCCH}⁽ⁿ⁾ (i) is the transmitting power of PUCCH required by the n^{th} eNB for correctly receiving the HARQ feedback information, that is, it's computed by using the parameters of the n^{th} eNB through the formula as follows:

$${P}_{PUCCH}^{( n )} ( i ) = min \{ \begin{matrix}{P}_{CMAX , c} ( i ) , \\ \begin{matrix}{P}_{O \_ PUCCH}^{( n )} + {PL}_{c}^{( n )} + h ( {n}_{CQI} , {n}_{HARQ} , {n}_{SR} ) + \\ {Δ}_{F \_ PUCCH}^{( n )} ( F ) + {Δ}_{TxD}^{( n )} ( {F}^{′} ) + {g}^{( n )} ( i )\end{matrix}\end{matrix} \}$$

wherein parameters P_{O}_{_{—}}_{PUCCH}⁽ⁿ⁾, PL_{c}⁽ⁿ⁾, Δ_{F}_{_{—}}_{PUCCH}⁽ⁿ⁾ (F), Δ_{TxD}⁽ⁿ⁾ (F′) and P_{CMAX,c} (i) are obtained from block 200, and parameter g⁽ⁿ⁾ (i) is obtained from block 205. Parameter h (n_{CQI}, n_{HARQ}, n_{SR}) is constant for eNBs with different sending directions, and the particular definitions thereof make a reference to 36.213 of 3GPP protocol.

The Second Application Case

According to the existing UE, when only one eNB is configured, the transmitting power P_{PUCCH} (i) of PUCCH for transmitting HARQ feedback information is computed through

$${P}_{PUCCH} ( i ) = min \{ \begin{matrix}{P}_{CMAX , c} ( i ) , \\ \begin{matrix}{P}_{O \_ PUCCH} + {PL}_{c} + h ( {n}_{CQI} , {n}_{HARQ} , {n}_{SR} ) + \\ {Δ}_{F \_ PUCCH} ( F ) + {Δ}_{TxD} ( {F}^{′} ) + g ( i )\end{matrix}\end{matrix} \} .$$

The transmitting power P_{PUCCH} (i) of PUCCH for transmitting HARQ feedback information is divided into two portions, one of which is the power control information reflecting the semi-static changes and is expressed as P_{PUCCH}_{_{—}}_{O}, for example, P_{PUCCH}_{_{—}}_{O} is defined as P_{PUCCH}_{_{—}}_{O}=P_{O}_{_{—}}_{PUCCH}+PL_{c}+h (n_{CQI}, n_{HARQ}, n_{SR})+Δ_{F}_{_{—}}_{PUCCH} (F)+Δ_{TxD} (F′), wherein P_{O}_{_{—}}_{PUCCH}, Δ_{F}_{_{—}}_{PUCCH} (F), Δ_{TxD} (F′), P_{CMAX,c} (i) are information for each eNB computed in step S201 through the information configured by high-level signaling and the path loss measured from RSRP. The other portion is the power control information g (i) which reflects the dynamic changes. In this way, the original formula can be expressed as:

$${P}_{PUCCH} ( i ) = min \{ \begin{matrix}{P}_{CMAX , c} ( i ) , \\ {P}_{PUCCH \_ O} + g ( i )\end{matrix} \} ..$$

The transmitting power P_{PUCCH} (i) for transmitting HARQ feedback information is computed by the steps of: in case of inter-eNB CA, each eNB has its own P_{PUCCH}_{_{—}}_{O} which reflects the initial transmitting power for an open-loop power control according to the link state of this eNB.

Since a plurality of eNBs have to correctly receive the HARQ feedback information sent by UE, the actual transmitting power of the UE should be the maximum one among the transmitting power values computed according to the link states of respective eNBs. P_{PUCCH}_{_{—}}_{O} of the n^{th} eNB is set as P_{PUCCHO}_{_{—}}_{O}⁽ⁿ⁾, then the P_{PUCCH}_{_{—}}_{O}^{max} can be defined as the maximum values of P_{PUCCH}_{_{—}}_{O}⁽ⁿ⁾ for respective eNBs, that is,

$${P}_{PUCCH \_ O}^{max} = {{max}_{n = 0}}^{N} {P}_{PUCCH \_ O}^{( n )} ,$$

which is the actual power of the UE for initially transmitting PUCCH based on open-loop power control. P_{PUCCH}_{_{—}}_{O}^{max} will not vary with the dynamic power control commands, and the power control of the subsequent UEs are performed on the basis of the initial transmitting power P_{PUCCH}_{_{—}}_{O}^{max}.

In the computation of the second portion g (i), UE records a single and unique parameter g (i−1) for a plurality of eNBs of the CA system, which is used for adjusting the transmitting power of respective uplink sub-frames. When determining the transmitting power of UE for the uplink sub-frame i, the dynamic power adjustment values

$${\sum }_{m = 0}^{M - 1} {δ}_{PUCCH}^{( n )} ( i - {k}_{m} )$$

of PUCCH for each configured eNB are obtained according to the dynamic power control command currently sent by respective eNBs for transmitting HARQ feedback information, respectively, among which the maximum value

$${{max}_{n = 0}}^{N - 1} ( {\sum }_{m = 0}^{M - 1} {δ}_{PUCCH}^{( n )} ( i - {k}_{m} ) )$$

is taken. The power adjustment value g (i) for the current moment is the sum of parameters g (i−1) and

$${{max}_{n = 0}}^{N - 1} ( {\sum }_{m = 0}^{M - 1} {δ}_{PUCCH}^{( n )} ( i - {k}_{m} ) ) .$$

That is, the power adjustment value

$$g ( i ) = g ( i - 1 ) + {{max}_{n = 0}}^{N} ( {\sum }_{m = 0}^{M - 1} {δ}_{PUCCH}^{( n )} ( i - {k}_{m} ) ) ,$$

In this way, for the uplink sub-frame i, the transmitting power of the UE can be computed as

$${P}_{PUCCH} ( i ) = min \{ \begin{matrix}{P}_{CMAX , c} ( i ) , \\ {P}_{PUCCH \_ O} + g ( i )\end{matrix} \}$$

upon the determination of the current power adjustment value g (i).

The Third Application Case

Still another method of computing transmitting power P_{PUCCH} (i) of PUCCH for transmitting HARQ feedback information consists in that, for the existing UE, when only one eNB is configured, the transmitting power P_{PUCCH} (i) of PUCCH for transmitting HARQ feedback information is

$${P}_{PUCCH} ( i ) = min \{ \begin{matrix}{P}_{CMAX , c} ( i ) , \\ \begin{matrix}{P}_{O \_ PUCCH} + {PL}_{c} + h ( {n}_{CQI} , {n}_{HARQ} , {n}_{SR} ) + \\ {Δ}_{F \_ PUCCH} ( F ) + {Δ}_{TxD} ( {F}^{′} ) + g ( i )\end{matrix}\end{matrix} \} ,$$

through which the initial transmitting power for each eNB can be computed respectively. That is, for the n^{th} eNB, the initial transmitting power is a sum of the power control information value P_{PUCCH}_{_{—}}_{O}⁽ⁿ⁾=P_{O}_{_{—}}_{PUCCH}⁽ⁿ⁾+PL_{c}⁽ⁿ⁾+h (n_{CQI}, n_{HARQ}, n_{SR})+Δ_{F}_{_{—}}_{PUCCH}⁽ⁿ⁾ (F)+Δ_{TxD}⁽ⁿ⁾ (F′) reflecting semi-static changes and the initial power adjustment value g⁽ⁿ⁾ (0), which can be expressed as

$${P}_{PUCCH}^{( n )} ( i ) = min \{ \begin{matrix}{P}_{CMAX , c} ( i ) , \\ {P}_{PUCCH \_ O}^{( n )} + {g}^{( n )} ( i )\end{matrix} \} .$$

Since the transmitting power of the UE for sending uplink signals actually is one. The actual initial transmitting power at the initial time should be arranged according to the eNB having the maximum P_{PUCCH}⁽ⁿ⁾ (0), in order to ensure all the eNBs can receive the HARQ feedback information. That is, the actual initial transmitting power of the UE is

$${P}_{PUCCH} ( 0 ) = {{max}_{n = 0}}^{N - 1} {P}_{PUCCH}^{( n )} ( 0 ) ,$$

wherein N is the number of the configured eNBs. Correspondingly, the initial power adjustment value g⁽ⁿ⁾ (0) for each eNB can be computed as the difference value between the actual transmitting power P_{PUCCH} (0) of PUCCH of the UE at initial time and the power control information value P_{PUCCH}_{_{—}}_{O}⁽ⁿ⁾ of the n^{th} eNB reflecting the semi-static changes, that is, g⁽ⁿ⁾ (0)=P_{PUCCH} (0)−P_{PUCCH}_{_{—}}_{O}⁽ⁿ⁾. With such method for arranging initial power adjustment value g⁽ⁿ⁾ (0), the actual initial power adjustment values at initial time for respective eNBs can be computed.

For the uplink sub-frame i, when computing the g⁽ⁿ⁾ (i) of the n^{th} eNB, the PUCCH dynamic power adjustment value

$${\sum }_{m = 0}^{M - 1} {δ}_{PUCCH}^{( n )} ( i - {k}_{m} )$$

of each configured eNB can be obtained in terms of the dynamic power control command for transmitting HARQ feedback information which is currently sent by respective eNB. Since the transmitting power of a UE on sub-frame i is one and only, the UE actually adjusts the transmitting power in terms of the eNB having the maximum power adjustment value

$${\sum }_{m = 0}^{M - 1} {δ}_{PUCCH}^{( n )} ( i - {k}_{m} ) .$$

That is, the power adjustment value actually utilized by the UE is

$${{max}_{n = 0}}^{N - 1} ( {\sum }_{m = 0}^{M - 1} {δ}_{PCCH}^{( n )} ( i - {k}_{m} ) ) .$$

That is, for the n^{th} eNB, the power adjustment value g⁽ⁿ⁾ (i) of the sub-frame i equals to the sum of g⁽ⁿ⁾ (i−1) and

$${{max}_{n = 0}}^{N - 1} ( {\sum }_{m = 0}^{M - 1} {δ}_{PCCH}^{( n )} ( i - {k}_{m} ) ) ,$$

i.e., the power adjustment value

$${g}^{( n )} ( i ) = {g}^{( n )} ( i - 1 ) + {{max}_{n = 0}}^{N} ( {\sum }_{m = 0}^{M - 1} {δ}_{PUCCH}^{( n )} ( i - {k}_{m} ) ) .$$

In this way, the transmitting power computed in terms the n^{th} eNB is the sum of the semi-statically configured, power information P_{PUCCH}_{_{—}}_{O}⁽ⁿ⁾ of the n^{th} eNB and the change g⁽ⁿ⁾ (i) in power of the n^{th} eNB at the current time, that is, P_{PUCCH} (i)=P_{PUCCH}⁽ⁿ⁾ (i)=P_{PUCCH}_{_{—}}_{O}⁽ⁿ⁾+g⁽ⁿ⁾ (i). Actually, the transmitting powers of UE computed in terms of respective eNBs are identical with each other.

Therefore, UE transmits the HARQ feedback information by using the transmitting power P_{PUCCH} (i)=P_{PUCCH}⁽ⁿ⁾ (i)=P_{PUCCH}_{_{—}}_{O}⁽ⁿ⁾+g⁽ⁿ⁾ (i) of PUCCH for transmitting HARQ feedback information, which is computed as above.

FIG. 6 illustrates a structural schematic view of a terminal device according to the embodiments of the present disclosure.

As shown in FIG. 6, the embodiments of the present disclosure also provide a terminal device 600 comprising a receiving module 610, a power controlling module 620, and a transmitting module 630.

The receiving module 610 is used for receiving semi-static power control parameters, as well as transmission power control commands (TPC), from the PCell eNB and the SCell eNB, respectively.

The power controlling module 620 is used for controlling a transmitting power for transmitting HARQ feedback information on PUCCH resource, according to the semi-static power control parameters and the TPC.

The transmitting module 630 is used for transmitting the HARQ feedback information through the PUCCH resource according to the transmitting power being controlled.

In particular, the receiving module 610 is further used for receiving PUCCH resource information sent by PCell eNB. Subsequently, the transmitting module 630 is used for transmitting HARQ feedback information by using PUCCH resource.

In particular, the semi-static power control parameters received by the receiving module 610 include P_{O}_{_{—}}_{PUCCH}, Δ_{F}_{_{—}}_{PUCCH} (F), Δ_{TxD} (F′), P_{CMAX,c} (i) and PL_{c}; the semi-static power control parameters are obtained by the receiving module 610 through receiving RRC signaling of PCell; wherein P_{O}_{_{—}}_{PUCCH}=P_{O}_{_{—}}_{NOMINAL}_{_{—}}_{PUCCH}+P_{O}_{_{—}}_{UE}_{_{—}}_{PUCCH} is a high-level configuration parameter.

In particular, the power controlling module 620 is used for controlling the PUCCH resource on sub-frame i to transmit HARQ feedback information at a transmitting power of P_{PUCCH} (i), according to the semi-static power control parameters and the TPC, comprising:

$${P}_{PUCCH} ( i ) = {{max}_{n = 0}}^{N} {P}_{PUCCH}^{( n )} ( i ) ,$$

wherein N is the number of the eNBs configured for the UE, P_{PUCCH}⁽ⁿ⁾ is the transmitting power required by the n^{th} eNB to correctly receive the HARQ feedback information,

$${P}_{PUCCH}^{( n )} ( i ) = min \{ \begin{matrix}{P}_{CMAX , c} ( i ) , \\ \begin{matrix}{P}_{O \_ PUCCH}^{( n )} + {PL}_{c}^{( n )} + h ( {n}_{CQI} , {n}_{HARQ} , {n}_{SR} ) + \\ {Δ}_{F \_ PUCCH}^{( n )} ( F ) + {Δ}_{TxD}^{( n )} ( {F}^{′} ) + {g}^{( n )} ( i )\end{matrix}\end{matrix} \}$$

$$g ( i ) = g ( i - 1 ) + {\sum }_{m = 0}^{M - 1} {δ}_{PUCCH} ( i - {k}_{m} ) ,$$

wherein δ_{PUCCH} (i−kₘ) is the value indicated by the TPC in the PDCCH for scheduling PDSCH on downlink sub-frame i−kₘ or the value indicated by the TPC in the form corresponding to the format 3/3A.

Parameters P_{O}_{_{—}}_{PUCCH}⁽ⁿ⁾, PL_{c}⁽ⁿ⁾, Δ_{F}_{_{—}}_{PUCCH}⁽ⁿ⁾ (F), Δ_{TxD}⁽ⁿ⁾ (F′) and g⁽ⁿ⁾ (i) are P_{O}_{_{—}}_{PUCCH}, Δ_{F}_{_{—}}_{PUCCH} (F).

In particular, the power controlling module 620 is used for controlling the PUCCH resource on sub-frame i to transmit HARQ feedback information at a transmitting power of P_{PUCCH} (i), according to the semi-static power control parameters and the TPC, comprising:

$${P}_{PUCCH} ( i ) = min \{ \begin{matrix}{P}_{CMAX , c} ( i ) , \\ {P}_{PUCCH \_ O}^{max} + g ( i )\end{matrix} \} ,$$

wherein

$${P}_{PUCCH \_ O}^{max} = {{max}_{n = 0}}^{N} {P}_{PUCCH \_ O}^{( n )} ,$$

and the P_{PUCCH}_{_{—}}_{O} of the n^{th} eNB is set as P_{PUCCH}_{_{—}}_{O}⁽ⁿ⁾, wherein P_{PUCCH}_{_{—}}_{O}=P_{O}_{_{—}}_{PUCCH}+PL_{c}+h (n_{CQI}, n_{HARQ}, n_{SR})+Δ_{F}_{_{—}}_{PUCCH} (F)+Δ_{TxD} (F′),

$${g}^{( n )} ( i ) = {g}^{( n )} ( i - 1 ) + {{max}_{n = 0}}^{N} ( {\sum }_{m = 0}^{M - 1} {δ}_{PUCCH}^{( n )} ( i - {k}_{m} ) ) .$$

δ_{PUCCH} (i−kₘ) is the value indicated by the TPC in the PDCCH for scheduling PDSCH on downlink sub-frame i−kₘ or the value indicated by the TPC in the form corresponding to the format 3/3A, and N is the number of the eNB configured for the UE.

In particular, the power controlling module 620 is used for controlling the PUCCH resource on sub-frame i to transmit HARQ feedback information at a transmitting power of P_{PUCCH} (i) according to the semi-static power control parameters and the TPC, comprising: P_{PUCCH} (i)=P_{PUCCH}_{_{—}}_{O}⁽ⁿ⁾+g⁽ⁿ⁾ (i),

wherein P_{PUCCH}_{_{—}}_{O}⁽ⁿ⁾=P_{O}_{_{—}}_{PUCCH}⁽ⁿ⁾+PL_{c}⁽ⁿ⁾+h (n_{CQI}, n_{HARQ}, n_{SR})=Δ_{F}_{_{—}}_{PUCCH}⁽ⁿ⁾ (F)+Δ_{TxD}⁽ⁿ⁾ (F′),

$${g}^{( n )} ( i ) = {g}^{( n )} ( i - 1 ) + {{max}_{n = 0}}^{N} ( {\sum }_{m = 0}^{M - 1} {δ}_{PUCCH}^{( n )} ( i - {k}_{m} ) ) .$$

the initial power adjustment value is set as g^{(n) (}0); the actual initial transmitting power is adjusted according to the eNB having the maximum P_{PUCCH}⁽ⁿ⁾ (0);

$${P}_{PUCCH} ( 0 ) = {{max}_{n = 0}}^{N - 1} {P}_{PUCCH}^{( n )} ( 0 ) ,$$

and wherein N is the number of the eNB configured for the UE; g⁽ⁿ⁾ (0)=P_{PUCCH} (0)−P_{PUCCH}_{_{—}}_{O}⁽ⁿ⁾. Computing g⁽ⁿ⁾ (i) of the n^{th} eNB for the uplink sub-frame i;

$${\sum }_{m = 0}^{M - 1} {δ}_{PUCCH}^{( n )} ( i - {k}_{m} )$$

is the PUCCH dynamic power adjustment value of each configured eNB, obtained in terms of the TPC for transmitting HARQ feedback information which is currently sending by the n^{th} eNB, n=0, 1 . . . N−1, M is the number of the downlink sub-frames corresponding to the HARQ feedback information transmitted on the sub-frame i.

Parameters P_{O}_{_{—}}_{PUCCH}⁽ⁿ⁾, PL_{c}⁽ⁿ⁾, Δ_{F}_{_{—}}_{PUCCH}⁽ⁿ⁾ (F), Δ_{TxD}⁽ⁿ⁾ (F′) and g⁽ⁿ⁾ (i) are P_{O}_{_{—}}_{PUCCH}, Δ_{F}_{_{—}}_{PUCCH} (F), Δ_{TxD} (F′), PL_{c} and g (i) for the n^{th} eNB, respectively.

The technical solutions proposed above by the present disclosure consist in computing the corresponding maximum transmitting power available under the current condition and properly configuring the transmitting power at the terminal device by comprehensive analysis of the power control parameters received from a plurality of eNBs so as to optimum the performances of the communication system. Additionally, the technical solutions described above by the present disclosure only modify the existing system to a minimized degree, which will not influence the compatibility thereof, and is easily and effectively to be implemented.

A person having ordinary skill in the art may understand that, the disclosure may relate to equipment for executing one or more operations described in the application. The equipment can be specially designed and manufactured for the required purpose, or can also include the equipment in general purpose computers that are selectively activated or reconstructed by programs stored therein. Such computer programs can be stored in device (for example, computer) readable medium or in any type of medium suitable for storing electronic instructions and respectively coupled to the bus. The computer readable medium can include but is not limited to any type of disk (including floppy disk, hard disk, CD, CD-ROM and magneto-optic disk), Random Access Memory (RAM), Read-Only Memory (ROM), electrically programmable ROM, electrically erasable ROM (EPROM), electrically erasable programmable ROM (EEPROM), flash memory, magnetic card or light card. The readable medium includes any of mechanism for storing or transmitting information in a device (for example, computer) readable form. For example, the readable medium includes RAM, ROM, disk storage medium, optical storage medium, flash memory device, and signals (for example, carrier, infrared signal and digital signal) transmitted in electric, optical, acoustic or other forms.

A person having ordinary skill in the art may understand that, each frame in these structure diagrams and/or block diagrams and/or flowcharts and combinations of frames in these structure diagrams and/or block diagrams and/or flowcharts can be implemented by computer program instructions. These computer program instructions can be provided to general-purpose computers, special-purpose computers or other processors of programmable data processing method to generate a machine, thus creating methods designated for implementing one or more frames in the schematic diagrams and/or the block diagrams and/or the flowcharts by instructions executed by the computers or other processors of programmable data processing method.

A person having ordinary skill in the art may understand that, the processes, measures and solutions in various operations, methods and flows which have been discussed in the present disclosure may be alternated, changed, combined or deleted. Further, other processes, measures and solutions in various operations, methods and flows which have been discussed in the present disclosure may also be alternated, changed, rearranged, decomposed, combined or deleted. Further, the processes, measures and solutions in various operations, methods and flows disclosed in the present disclosure in may also be alternated, changed, rearranged, decomposed, combined or deleted.

The above is only a part of implementations of the present disclosure. Although the present disclosure has been described with examples, various changes and modifications may be suggested to one skilled in the art. It is intended that the present disclosure encompass such changes and modifications as fall within the scope of the appended claims.

What is claimed is:

1. A method for controlling a transmitting power by a User Equipment (UE) in a carrier aggregation system across the enhanced Node Bs (eNBs) comprising:
receiving a transmission power control command (TPC) from a first eNB and a second eNB; and
controlling a transmitting power for feedback information on a Physical Uplink Control Channel (PUCCH) resource received from the first eNB using the TPC.

2. The method according to claim 1, further comprising when the first eNB sends information on a interference level subjected by resource for the feedback information to the second eNB, confirming the information on the PUCCH resource, by the first eNB, according to a suggestion on resource to be utilized by the PUCCH which is sent from the SCell eNB as a feedback.

3. The method according to claim 1, further comprising when the first eNB receives information on the interference level subjected by the resource for the feedback information sent from the SCell eNB, confirming the information on the PUCCH resource is confirmed according to the information on the interference level.

4. The method according to claim 1, further comprising computing a path loss by the UE.

5. The method according to claim 4, further comprising measuring a reference signal received power (RSRP) by the UE.

6. The method according to claim 5, wherein the TPC includes:
a basic open-loop working point of power control for transmitting the feedback information on the PUCCH to each the first eNB and the second eNB,
a deviation value of the PUCCH with certain format by comparing to a reference PUCCH,
a deviation value for transmitting the PUCCH by using two antenna ports,
a maximum transmitting power on cell c of the UE, and
a path loss computed by the UE using a formula that subtracts a reference signal received power (RSRP) measured by the UE from a transmitting power of cell reference symbol (CRS).

7. The method according to claim 1, wherein the first eNB is a primary cell and the second eNB is a secondary cell.

8. The method according to claim 1, wherein the first eNB is a secondary cell.

9. A User Equipment (UE) for controlling a transmitting power in a carrier aggregation system across the enhanced Node Bs (eNBs), the UE comprising:
a receiving module configured to receive a transmission power control command (TPC) from a first eNB and a second eNB;
a power controlling module configured to control a transmitting power for feedback information on a Physical Uplink Control Channel (PUCCH) resource received from the first eNB using the TPC; and
a transmitting module configured to transmit the feedback information through the PUCCH resource using the controlled transmitting power.

10. The UE according to claim 9, wherein the power controlling module is further configured to control a transmitting power for feedback information on the PUCCH resource when the first eNB sends information on an interference level subjected by resource for the feedback information to the second eNB, wherein the information on the PUCCH resource is confirmed by the first eNB according to a suggestion on resource to be utilized by the PUCCH which is sent from the SCell eNB as a feedback.

11. The UE according to claim 9, wherein the power controlling module is further configured to control a transmitting power for feedback information on the PUCCH resource when the first eNB receives information on the interference level subjected by the resource for the feedback information sent from the SCell eNB, wherein the information on the PUCCH resource is confirmed according to the information on the interference level.

12. The UE according to claim 9, further configured to compute a path loss.

13. The UE according to claim 12, further configured to measure a reference signal received power (RSRP).

14. The UE according to claim 13, wherein the TPC includes:
a basic open-loop working point of power control for transmitting the feedback information on the PUCCH to each the first eNB and the second eNB,
a deviation value of the PUCCH with certain format by comparing to a reference PUCCH,
a deviation value for transmitting the PUCCH by using two antenna ports,
a maximum transmitting power on cell c of the UE, and
a path loss computed by the UE using a formula that subtracts the RSRP measured by the UE from a transmitting power of cell reference symbol (CRS).

15. A wireless communication system for controlling a transmitting power in a carrier aggregation system across the enhanced Node Bs (eNBs), the system comprising:
a first eNB and a second eNB;
a User Equipment (UE) comprising:
a receiving module configured to receive a transmission power control command (TPC) from each of the first eNB and the second eNB;
a power controlling module configured to control a transmitting power for feedback information on a Physical Uplink Control Channel (PUCCH) resource received from the first eNB using the TPC; and
a transmitting module configured to transmit the feedback information through the PUCCH resource using the controlled transmitting power.

16. The system according to claim 15, wherein the first eNB is a primary cell and the second eNB is a secondary cell.

17. The system according to claim 15, wherein the first eNB is a secondary cell.

18. The system according to claim 15, wherein when the first eNB sends information on an interference level subjected by resource for the feedback information to the second eNB, wherein the information on the PUCCH resource is confirmed by the first eNB according to a suggestion on resource to be utilized by the PUCCH which is sent from the SCell eNB as a feedback.

19. The system according to claim 18, when the first eNB receives information on the interference level subjected by the resource for the feedback information sent from the SCell eNB, wherein the information on the PUCCH resource is confirmed according to the information on the interference level.

20. The system according to claim 15, wherein the TPC includes:
a basic open-loop working point of power control for transmitting the feedback information on the PUCCH to each the first eNB and the second eNB,
a deviation value of the PUCCH with certain format by comparing to a reference PUCCH,
a deviation value for transmitting the PUCCH by using two antenna ports,
a maximum transmitting power on cell c of the UE, and
a path loss computed by the UE using a formula that subtracts the RSRP measured by the UE from a transmitting power of cell reference symbol (CRS).
